(19) United States
(12) Patent Application Publication
(10) Pub. No.: US 2005/0252072 A1
(43) Pub. Date: Nov. 17, 2005

(54) Fish bait

(76) Inventors: Garath G. Cross, Pembrokeshire (GB); Michael J. Dowdall, Nottingham (GB)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002, US

(21) Appl. No.: 10/516,200

(22) PCT Filed: May 30, 2003
(86) PCT No.: PCT/GB03/02366

§ 371 Date: May 12, 2005

(30) Foreign Application Priority Data
May 30, 2002 (GB) 02125383

(51) Int. Cl. A01K 85/00

(52) U.S. Cl. 43/42; 424/84

(57) ABSTRACT

There is disclosed a fish bait comprising L-proline and a natural bait material held in a slow-release matrix, wherein the L-proline is present in an amount greater than that found in the natural bait material. The bait is intended mainly for use in commercial long-line fishing.

This invention relates to a fish bait, in particular to a fish bait intended for use in commercial long-line fishing. The bait also has application in sport and leisure fishing.

Most fishermen today use fish-based bait for hook and line fishing. The bait is purchased either fresh or frozen. In the commercial fishing sector, where vessels can fish with up to 100,000 hooks at once, fish baits ranging from 10-23 grams in weight are used. Currently, the price of baitfish is rising relentlessly, making this one of the largest costs in commercial fishing.

The two main methods of commercial fishing are long-lining and trawling. Long-line fishing uses a very long fishing line that has baited hooks along its length. This line is set out in the sea at a specified depth using weights, left for several hours and then hauled back on to the boat, the fish being removed from the hooks as they enter the boat. Fishing can be continuous, shooting one line whilst hauling in another. Trawling involves towing a huge net behind the fishing vessel for between 3 and 5 hours at an average speed of approximately 3 mph. The net is then hauled in and landed on deck. Another 2 hours is spent removing the fish from the net, repairing and re-setting the net ready to shoot again for the next trawl. The energy consumption of a long-line vessel is much less than that of a trawler of the same size. In long lining, one only has to haul the weight of the line. Trawling entails dragging a huge net for hours at a time, which requires a huge amount of energy. A long-line vessel can also fish in much rougher seas (up to Gale Force 9) than a trawler (usually up to Gale Force 6).

Long lining is a very environmentally friendly method of fishing. Since only a certain size hook is used on the fishing line, only fish large enough to swallow the hook and the bait will be caught. Undersize fish are rarely caught on a long-line vessel. These younger fish are therefore left in the sea to grow and reproduce, thus helping to sustain fish stocks. All of the fish caught are of the desired minimum size and can all be kept and landed. In this way, using hooks of the appropriate size can target fish of a specified size. There are no discards from a long-line vessel.

Overall, fish caught by long lining are of a higher quality than those caught by trawling. In trawling, fish caught earlier on when one first starts towing the trawl net will end up in the back end of the net, known as the “cod-end”. As more and more fish are caught, these become packed on top of the “cod-end” fish, squashing and damaging them, hence lowering their quality and market price. Fish entangled in the net can also sustain damage, which reduces their value. Fish caught by long lining have a higher market value because they are relatively undamaged. Each fish is caught separately on a single hook.

Traditionally, the average size bait for long lining is 10 to 15 grams, usually of prime fish. Current long-lining bait used in this area is mackerel, which can be classed as a prime eating fish, not a fish to be used as bait. Such fish is therefore relatively expensive. Present long-line vessels require huge storage freezer units to keep the baitfish on board.

One of the problems current long-liners face is the efficiency of baiting. For example, using whole mackerel as bait, the whole fish is fed onto an autobaiter. As the line shoots out from the back of the boat, the autobaiter slices the mackerel into 5 or 6 chunks. The hooks shoot through each slice of fish and out into the sea. Baiting in this way often means that only 4 out of the 6 slices of fish actually end up on the hooks, reducing the overall percentage of baited hooks. This will in turn reduce fish capture, since fish will not swallow an unbaited hook. This reduction in efficiency is due in turn to the shape of a fish, in that the tapered head and tail ends are harder to bait on the hooks. Also, the frozen state of the fish affects baiting efficiency, in that if the bait is too hard or too soft, the hook's baiting success is reduced.

Another major problem long-liners face is bait loss during fishing. A certain percentage of the hooked baits are lost through “drop-offs”. When the line is shot out from the back of the boat, a percentage of the baits “drop off” on impact with the water. During the fishing period when the line is underwater, a certain percentage of baits are lost through “suck offs”. This is when fish actually suck the bait off without swallowing the hook. In this way, a number of baits can be lost before the fish is actually caught. Statistics have shown that up to 20% of long-line fish baits are lost by “drop-offs” and “suck offs”. This marks a significant reduction in potential fishing efficiency.

In recent years, birds such as albatrosses have been taking baits from the hooks on the line as it is shot out from the back of the boat (when setting the line). Bird mortality was high, due to injury from the hooks. This problem has now been resolved, in that the line is now shot from beneath the boat directly underwater, preventing the birds from stealing the baits and simultaneously increasing fishing efficiency because a higher percentage of hooks are baited successfully.

According to the present invention, there is provided a fish bait comprising L-proline and a natural bait material held in a slow-release matrix, wherein the L-proline is present in an amount greater than that found in the natural bait material.

In a preferred embodiment, there is provided a fish bait comprising a non-woven textile substrate that supports:
a slow-release water-degradable polymer having therein L-proline as a chemical attractant for the fish; and
ground freeze-dried fish as a phagostimulant for the fish.

The bait of the invention can have the following advantages:
1. it need weigh no more than three grams;
2. it can be dry, so that it can be shipped anywhere in the world;
3. it can be capable of attracting many different species of fish;
4. it can have a good shelf life, and
5. it can be relatively cheap to produce.

The bait can be in two main forms, namely bait which will work over a three to five hour period for the commercial sector, and bait which will work over a thirty minute to one hour period for the sporting market. Different formulations of the bait can be developed to suit different species of fish.

The bait may consist of five elements, which are further described below:
1. Man-made non-woven textile or other support medium;
2. Water-degradable polymer which may be in pre-hydrated form or in hydratable form;
3. Chemical attractant;
4. Phagostimulant;
5. Chemoluminescence.

The support medium such as textile matrix is the structural “back-bone” of the bait. It has to be sufficiently flexible to be penetrated by a fish-hook during the hook loading process and then for it not to fall off the hook while in the sea by friction as it goes through the water. The bait must also not be too tightly attached to the hook so that it can be removed when the lines are drawn in and the hooks are cleaned of bait before being used again. The matrix will also provide the bait with a “ribbon-like” appearance that can help to act as a visual stimulus.

Often, when shooting baits from commercial fishing vessels, up to 20% of the baits are lost due to “drop off”, as they cannot be firmly attached to the hook. In addition to this, it has been found that mature cod can “suck” fish baits off the hooks from a distance, a single cod taking up to 20 baits in this way before finally being caught.

For these reasons, the choice of material is important to the success of the bait. It is desirable to use a textile made from natural fibres that will stay firmly attached to the hook, but which can also be removed by hook cleaning machinery.

The slow-release water degradable polymer serves two purposes:
1. it is the means by which the chemical attractant is released from the bait into the water during the time the bait is in the sea; and
2. it provides, in combination with the non-woven matrix, the surface texture properties required to give the responding fish the impression that it is biting into real fish bait.

Preferably, the polymer is carrageenin or other hydrocolloid.

The chemical attractant lures the target fish to the bait when it dissolves in the water. The chemical acts as a “signal” to the target fish that there is a live prey fish nearby for it to eat. Aquarium tests have shown that fish will readily come towards the “smell” of this chemical in the water, believing it to be fresh food.

The chemical attractant is L-proline, which is preferably present in an amount of about 3 to 7% by weight;

A small amount of dried fish, usually 2 to 10%, more usually 2 to 4%, may be added as a phagostimulant to the bait to provide a taste, as the chemical attractant has no flavour. The more the bait tastes like real fish, the longer the fish will hang on and the greater the chance of being hooked.

It is also possible for the tip of the bait cloth to contain a light-activated chemiluminescent material. This would add an extra element of attraction to the bait for certain fish species that tend to use their eyes initially to locate their food, rather than their sense of smell.

The object is to produce the bait as a length of material, which will be sliced and hooked in a similar fashion to whole fish. However, baiting efficiency is much higher because the material will be of constant size and strength. It is just a matter of engineering the autobaiter to suit the new bait.

Because of the design of the bait, its size and strength means that the percentage of baits lost during fishing can be dramatically reduced, if not almost completely eradicated. Fish capture efficiency can therefore be much higher, thereby increasing profitability.

The bait is much easier to store and transport than frozen fish currently used as bait. Long-line bait such as mackerel are frozen whole and have a storage life of approximately one year at a temperature of −40° C. Transporting such a bulky bait is very expensive. At the same storage temperature, the bait of the present invention could be stored indefinitely. Thus, the bait can be quickly, cheaply and easily transported around the world without the need for large freezer units.

The bait of the present invention need only weigh a few grams (2-3 g) and would therefore not require vast amounts of expensive prime fish bait. The actual fish constituent of the bait is minimal. It would not be necessary to have huge storage units on board. A standard domestic freezer would be able to store all of the bait needed during a fishing trip. The vessel would therefore save on fuel and deck space. If the bait were manufactured dry for hydration prior to use then the savings on storage would be even greater.

The design of the bait allows one to use different “flavours” to be able to target the particular fish species on the fishing grounds, something which has never before been possible. For example, in the North Sea, cod feed on many different species depending on their availability at a particular time of year. One of their preferred prey is squid. During the spring, sand eels are abundant and are one of the main food sources. Squid, however, are not abundant during spring, but are more abundant in early autumn when they congregate to mate, at which time they become an easier target. By using a squid flavoured bait, one would hope to latch on to the cod's food preference and hopefully catch more fish. Thus, one can target particular fish species very accurately. This could be a major breakthrough in commercial fishing and if managed properly could put a stop to the decline of the world's fish stocks.

It will also be possible to target flatfish such as plaice, brill, turbot, etc. Previously, it was thought that the only effective method for flatfish fishing was “beam-trawling”. This is probably the most destructive method of fishing known to man. Beam trawling involves dragging a huge, weighted beam along the sea bed, which churns up all of the benthic (bottom-dwelling) sea life. Behind the beam is a large trawl net. The disturbed fish (along with much of the other benthic marine life) is swept up into the beam trawl net. Fishing in this way drastically destroys the sea bed environment. Just by trawling over an area once does enough damage that it can take many years to recover to a level at which it can be fished again.

Bottom fishing by long-lining with the bait of the present invention means that one can effectively target flatfish without disturbing any of the other benthic life which is vital to the survival of this bottom dwelling community. This would hopefully reduce beam trawling due to the efficiency of long-line fishing. Long-liners also enable rough ground and much deeper waters to be fished, something that trawlers cannot do.

1. A long line fish bait for sea fishing comprising L-proline and a natural bait material held in a slow-release matrix wherein the slow-release matrix is a slow-release water-degradable polymer in a hydratable form, and wherein the L-proline is present in an amount greater than that found in the natural bait material.

2. A bait according to claim 1, wherein the L-proline is present in an amount of about 3 to 7% by weight, preferably about 5% by weight.

3. A bait according to claim 2, wherein the water-degradable polymer is carrageenan or other hydrocolloid.

4. A bait according to any of claims 1 to 3 wherein the natural bait material is ground freeze-dried fish.

5. A bait according to claim 4, wherein the ground freeze-dried fish is present in an amount of 2 to 10% by weight, preferably 2 to 4% by weight.

6. A bait according to any of claims 1 to 5, further comprising a light-activated chemiluminescent material.

7. A bait according to any of claims 1 to 6, supported on a textile substrate or other support medium.

8. A long line-fish bait for sea fishing comprising a textile substrate that supports:
a slow-release water-degradable polymer having therein L-proline as a chemical attractant for the fish; and
ground freeze-dried fish as a phagostimulant for the fish.

9. Use of a fish bait according to any of claims 1 to 8 as a bait in long-line sea fishing.

10. Use of a fish bait according to any of claims 1 to 8 as a bait in long-line sea fishing for cod.

11. Use of a fish bait to which L-proline has been added as a bait in long-line sea fishing for cod.

12. Use of a fish bait according to any of claims 1 to 8 as a bait in marine sport sea fishing.

13. Use of a fish bait according to any of claims 1 to 8 for feeding farmed sea fish.
